(19) United States
(12) Patent Application Publication
(10) Pub. No.: US 2023/0097244 A1
(43) Pub. Date: Mar. 30, 2023

(54) INFORMATION PROCESSING APPARATUS, INFORMATION PROCESSING METHOD, AND NON-TRANSITORY COMPUTER READABLE MEDIUM STORING A PROGRAM

(71) Applicant: TOYOTA JIDOSHA KABUSHIKI KAISHA, Toyota-shi (JP)

(72) Inventors: Yuta ISHIKO, Nagoya-shi (JP); Shuji NAKAGAWA, Toyota-shi (JP)

(73) Assignee: TOYOTA JIDOSHA KABUSHIKI KAISHA, Toyota-shi (JP)

(21) Appl. No.: 17/881,370

(22) Filed: Aug. 4, 2022

(30) Foreign Application Priority Data
Sep. 29, 2021 (JP) 2021-159572

(51) Int. Cl. G06Q 30/02; B60H 3/00

(52) U.S. Cl. CPC G06Q 30/0206; B60H 3/0085

(57) ABSTRACT

To appropriately conduct assessments of used vehicles. An information processing apparatus includes: an acquisition unit configured to acquire information indicating the strength of each type of odor in the interior of a vehicle; and a control unit configured to calculate the price regarding the value of the vehicle based on the information acquired by the acquisition unit.

### CROSS REFERENCE TO RELATED APPLICATIONS

This application is based upon and claims the benefit of priority from Japanese patent application No. 2021-159572, filed on Sep. 29, 2021, the disclosure of which is incorporated herein in its entirety by reference.

### BACKGROUND

The present disclosure relates to an information processing apparatus, an information processing method, and a program.

Systems for conducting assessments of used vehicles have been known (see, for example, Japanese Unexamined Patent Application Publication No. 2003-006476).

### SUMMARY

In related art, however, for example, assessments of used vehicles may not be appropriately conducted.

An object of the present disclosure is to provide an information processing apparatus, an information processing method, and a program capable of appropriately conducting assessments of used vehicles.

In a first aspect according to the present disclosure, an information processing apparatus includes: an acquisition unit configured to acquire information indicating the strength of each type of odor in the interior of a vehicle; and a control unit configured to calculate the price regarding the value of the vehicle based on the information acquired by the acquisition unit.

Further, in a second aspect according to the present disclosure, an information processing method including: acquiring information indicating the strength of each type of odor in the interior of a vehicle; and calculating the price regarding the value of the vehicle based on the acquired information is provided.

Further, in a third aspect according to the present disclosure, a program for causing a computer to execute processing of: acquiring information indicating the strength of each type of odor in the interior of a vehicle; and calculating the price regarding the value of the vehicle based on the acquired information is provided.

According to one aspect, it is possible to appropriately conduct assessments of used vehicles.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing a configuration example of an assessment system 1 according to an embodiment;

FIG. 2 is a diagram showing a hardware configuration example of a server 10 according to the embodiment;

FIG. 3 is a diagram showing one example of a configuration of the server 10 according to the embodiment;

FIG. 4 is a flowchart showing one example of processing of the server 10 according to the embodiment;

FIG. 5 is a diagram showing one example of a sensor sensitivity DB 501 according to the embodiment;

FIG. 6 shows one example of a vehicle base price DB 601 according to the embodiment;

FIG. 7 shows one example of a current depreciation price DB 701 according to the embodiment; and

FIG. 8 shows one example of an odor reduced price DB 801 according to the embodiment.

### DESCRIPTION OF EMBODIMENTS

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

Hereinafter, with reference to the drawings, embodiments of the present disclosure will be described.

### <System Configuration>

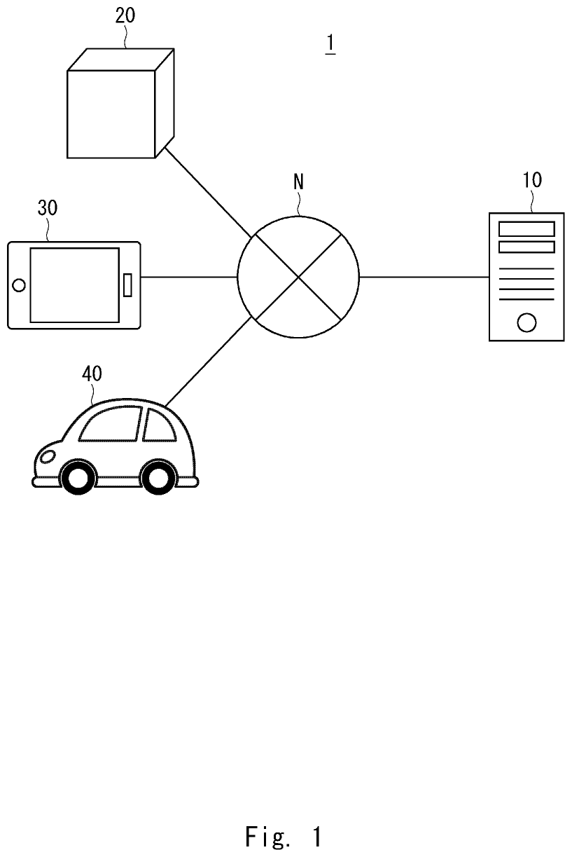

Referring to FIG. 1, a configuration of an assessment system 1 according to an embodiment will be described. FIG. 1 is a diagram showing a configuration example of the assessment system 1 according to the embodiment. In the example shown in FIG. 1, the assessment system 1 includes an odor detection apparatus 20, an assessment terminal 30, a vehicle 40, and a server 10. Note that the number of odor detection apparatuses 20, the number of assessment terminals 30, the number of vehicles 40, and the number of servers 10 are not limited to those shown in FIG. 1. Note that each of the odor detection apparatus 20, the assessment terminal 30, and the server 10 is one example of an “information processing apparatus”.

In the example shown in FIG. 1, the odor detection apparatus 20, the assessment terminal 30, the vehicle 40, and the server 10 are connected to one another in such a way that they can communicate with one another by a network N. The network N may be, for example, a bus, near-field communication such as Bluetooth (registered trademark) Low Energy (BLE), Local Area Network (LAN), wireless LAN, the Internet, and a mobile communication system. The mobile communication system may include, for example, a fifth generation mobile communication system (5G), a fourth generation mobile communication system (4G), or a third generation mobile communication system (3G).

Note that at least two apparatuses of the odor detection apparatus 20, the assessment terminal 30, and the server 10 may be configured as an integrated apparatus. The apparatus thus configured is included in the examples of the “information processing apparatus” of the present disclosure. In this case, for example, the odor detection apparatus 20 and the assessment terminal 30 may be configured as an integrated apparatus. Alternatively, for example, the assessment terminal 30 and the server 10 may be configured as an integrated apparatus. Alternatively, for example, the odor detection apparatus 20, the assessment terminal 30, and the server 10 may be configured as an integrated apparatus.

The odor detection apparatus 20 is an apparatus including an odor sensor. The odor detection apparatus 20 may be installed, by a person in charge of an assessment operation, inside the vehicle 40 to be assessed when, for example, the operation of assessing the used vehicle 40 is performed. The odor detection apparatus 20 transmits odor information based on information detected by the odor sensor to the assessment terminal 30.

The assessment terminal 30 is, for example, a terminal that the person in charge who performs the operation of assessing the used vehicle 40 uses. The assessment terminal 30 may be, for example, a terminal such as a tablet, a smartphone, or a notebook personal computer (PC). The assessment terminal 30 may receive, for example, vehicle information such as the type, the model year and the like of the vehicle 40 to be assessed, and current status information of scratches, dents, dirt and the like of the vehicle 40 from the person in charge. Further, the assessment terminal 30 may acquire odor information inside (interior of) the vehicle 40 to be assessed from the odor detection apparatus 20. Then, the assessment terminal 30 may transmit the vehicle information, the current status information, and the odor information to the server 10.

The server 10 may be a computer, a tablet, a smartphone, or a notebook PC for a server. The server 10 calculates the value (assessment price or purchase price) of the vehicle 40 to be assessed based on the information acquired from the assessment terminal 30 and causes the assessment terminal 30 to display the calculated value.

### <Hardware Configuration>

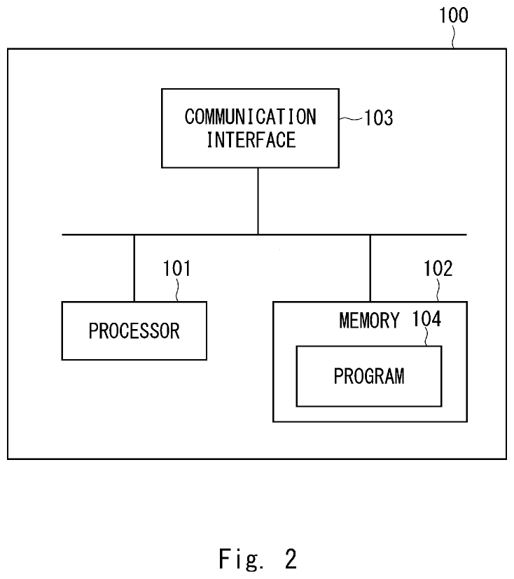

FIG. 2 is a diagram showing a hardware configuration example of the server 10 according to the embodiment. In the example shown in FIG. 2, the server 10 (computer 100) includes a processor 101, a memory 102, and a communication interface 103. Each of these components may be connected, for example, by a bus. The memory 102 stores at least a part of a program 104. The communication interface 103 includes an interface that is required to communicate with other network elements.

When the program 104 is executed by cooperation with the processor 101, the memory 102 and the like, at least a part of the processing of the embodiment of the present disclosure is performed by the computer 100. The memory 102 may be of any type suitable to the local technical network. The memory 102 may be, as non-limiting examples, a non-transitory computer readable medium. Further, the memory 102 may be implemented using any suitable data storage technology, such as semiconductor-based memory devices, magnetic memory devices and systems, optical memory devices and systems, fixed memory and removable memory. While only one memory 102 is shown in the computer 100, there may be several physically distinct memory modules in the computer 100. The processor 101 may be of any type. The processor 101 may include one or more of general purpose computers, special purpose computers, microprocessors, digital signal processors (DSPs) and processors based on multicore processor architecture, as non-limiting examples. The computer 100 may have multiple processors, such as an application specific integrated circuit chip that is slaved in time to a clock which synchronizes the main processor.

The embodiments of the present disclosure may be implemented in hardware or special purpose circuits, software, logic or any combination thereof. Some aspects may be implemented in hardware, while other aspects may be implemented in firmware or software which may be executed by a controller, microprocessor, or other computing device.

The present disclosure also provides at least one computer program product tangibly stored on a non-transitory computer readable medium. The computer program product includes computer-executable instructions, such as those included in program modules, being executed in a device on a target real or virtual processor, to carry out the process or method according to the present disclosure. Program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The program can be stored and provided to a computer using any type of non-transitory computer readable media. Non-transitory computer readable media include any type of tangible storage media. Examples of non-transitory computer readable media include magnetic storage media, optical magnetic storage media, semiconductor memories, etc. The magnetic storage media include, for example, flexible disks, magnetic tapes, hard disk drives, etc. The optical magnetic storage media include, for example, magneto-optical disks. The magneto-optical disks include Blu-ray disk, Compact Disc (CD)-Read Only Memory (ROM), CD-Recordable (R), CD-ReWritable (RW), etc. The semiconductor memories include, for example, a solid state drive, mask ROM, Programmable ROM (PROM), Erasable PROM (EPROM), flash ROM, Random Access Memory (RAM), etc. Further, the program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### <Configuration>

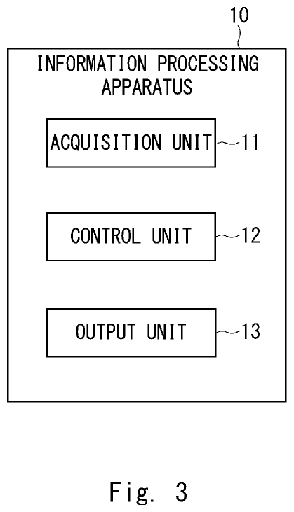

Referring to FIG. 3, a configuration of the server 10 according to the embodiment will be described. FIG. 3 is a diagram showing one example of the configuration of the server 10 according to the embodiment. In the example shown in FIG. 3, the server 10 includes an acquisition unit 11, a control unit 12, and an output unit 13. Each of these units may be implemented by cooperation with one or more programs installed in the server 10 and hardware such as the processor 101, the memory 102 and the like of the server 10.

The acquisition unit 11 acquires various kinds of information from a storage unit inside the server 10 or an external apparatus. The acquisition unit 11 acquires, for example, information indicating the strength of odors in the interior of the vehicle 40 for each type of the odors.

The control unit 12 calculates, based on the information acquired by the acquisition unit 11, the price and the like regarding the value of the vehicle 40. The output unit 13 outputs information which is based on the price and the like regarding the value of the vehicle 40, the information being calculated by the control unit 12.

### <Processing>

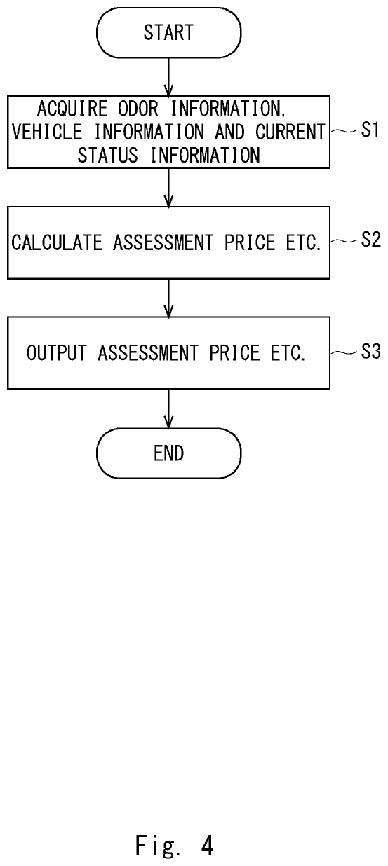

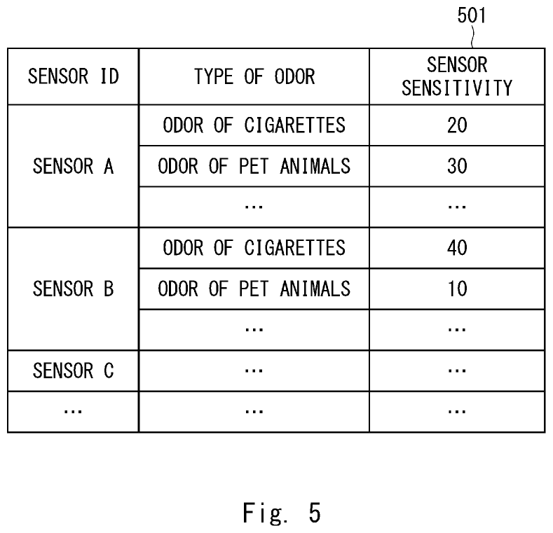

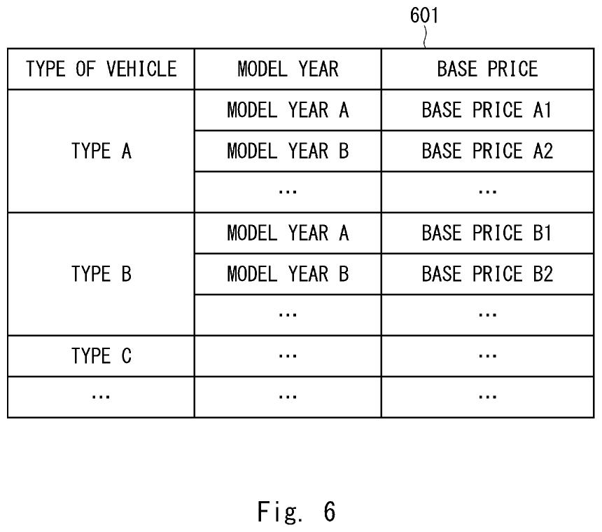

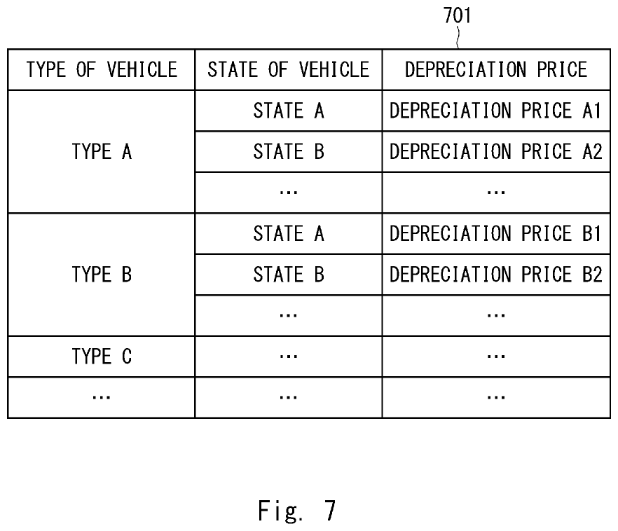

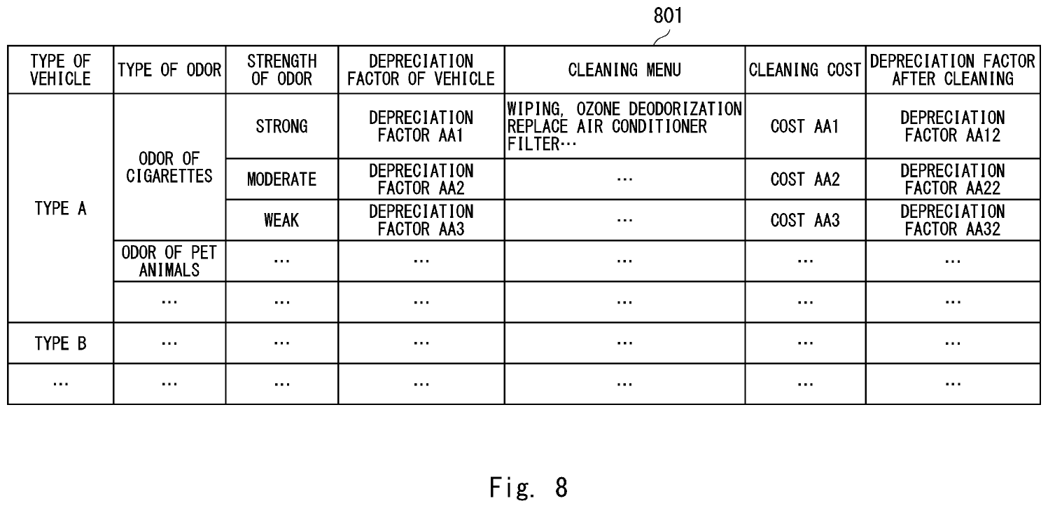

Referring next to FIGS. 4 to 8, one example of processing of the server 10 according to the embodiment will be described. FIG. 4 is a flowchart showing one example of the processing of the server 10 according to the embodiment. FIG. 5 shows one example of a sensor sensitivity DB (database) 501 according to the embodiment. FIG. 6 shows one example of a vehicle base price DB 601 according to the embodiment. FIG. 7 shows one example of a current depreciation price DB 701 according to the embodiment. FIG. 8 shows one example of an odor reduced price DB 801 according to the embodiment.

In Step S1, the acquisition unit 11 of the server 10 acquires the odor information detected by the odor detection apparatus 20 and the vehicle information and the current status information input to the assessment terminal 30. The odor information includes information indicating the strength of the odors in the interior of the vehicle 40 for each type of the odors. Note that the types of the odors may include those of cigarettes, pet animals, mold, air freshener and the like.

The information indicating the strength of the odors in the interior of the vehicle 40 for each type of the odors may include output values (detected values) in the respective sensors that the odor detection apparatus 20 includes, the sensitivities of the respective sensors to the odors of the respective types being different from one another. Then, the control unit 12 of the server 10 may calculate each of the strengths of the odors of the respective types based on information on the sensitivities of the respective sensors to the odors of the respective types, the information being recorded in the sensor sensitivity DB 501, and the output values in the respective sensors acquired by the acquisition unit 11. Note that data in the sensor sensitivity DB 501 in FIG. 5 may be recorded in a storage apparatus inside the server 10 or may be recorded in an external apparatus such as a DB server. The data in the sensor sensitivity DB 501 in FIG. 5 is recorded (registered or set) in advance by a manager (operator).

In the example shown in FIG. 5, information on the sensor sensitivity is registered in the sensor sensitivity DB 501 in association with a set of a sensor ID and the type of the odor. The sensor ID is identification information of a sensor included in the odor detection apparatus 20. The sensor sensitivity is the degree of the magnitude of a value output from a sensor when gas of an odor of each type has contacted the sensor. The example shown in FIG. 5 shows that the output value (signal intensity) from the sensor A becomes 20 when the sensor A has contacted gas of a given concentration with an odor of cigarettes, and the output value from the sensor 40 becomes 40 when the sensor B has contacted this gas. FIG. 5 further shows that the output value from the sensor A becomes 30 when the sensor A has contacted gas of a given concentration with an odor of pet animals and the output value from the sensor B becomes 10 when the sensor B has contacted this gas. The data in the sensor sensitivity DB 501 in FIG. 5 may be determined based on, for example, results of experiments in actual equipment for sensors of different manufacturers or models.

The number of sensors that the odor detection apparatus 20 includes, each having different sensitivities to the odors of the respective types, may be larger than the number of types of the odors to be determined. In this case, the control unit 12 of the server 10 is able to calculate the strength of the odors for each type of the odors by solving simultaneous equations based on the output values in the respective sensors that have been acquired and the sensitivity to each type of the odors in each sensor recorded in the sensor sensitivity DB 501.

Further, the vehicle information may include, for example, information on the type, the model year and the like of the vehicle 40 to be assessed. Further, the current status information may include, for example, information indicating scratches, dents, dirt and the like of the vehicle 40.

Next, the control unit 12 of the server 10 calculates the assessment price of the vehicle 40 to be assessed (one example of “the price regarding the value of the vehicle”) based on the information acquired by the acquisition unit 11 (Step S2). In this step, the server 10 may refer to, for example, the vehicle base price DB 601 in FIG. 6, the current depreciation price DB 701 in FIG. 7, and the odor reduced price DB 801 in FIG. 8 and calculate the assessment price and the like of the vehicle 40 to be assessed based on the information acquired by the acquisition unit 11. Each of the vehicle base price DB 601 in FIG. 6, the current depreciation price DB 701 in FIG. 7, and the odor reduced price DB 801 in FIG. 8 may be recorded in a storage apparatus inside the server 10 or may be recorded in an external apparatus such as a DB server. The data in the vehicle base price DB 601 in FIG. 6, the current depreciation price DB 701 in FIG. 7, and the odor reduced price DB 801 in FIG. 8 is recorded (registered or set) in advance by, for example, a manager (operator).

In the example shown in FIG. 6, the base price is registered in the vehicle base price DB 601 in association with the set of the type of the vehicle and the model year. The type of the vehicle may include, for example, the name of the car (name of its model). The model year may be the year in which the vehicle was manufactured or the year in which it was first registered in the country. The base price is a base price of the assessment price of the vehicle.

In the example shown in FIG. 7, the depreciation price is registered in the current depreciation price DB 701 in association with the set of the type of the vehicle and the state of the vehicle. The state of the vehicle may include, for example, information indicating the degrees of scratches and dents on the vehicle. The depreciation price is a depreciation price of the vehicle from the base price of the assessment.

In the example shown in FIG. 8, the depreciation factor, the cleaning menu, the cleaning cost, and the depreciation factor after cleaning are registered in the odor reduced price DB 801 in association with the set consisting of the type of the vehicle, the type of the odor, and the strength of the odor. The depreciation factor is a rate by which the original assessment price is reduced due to odors inside the vehicle. When, for example, the depreciation factor is 0.9, the original assessment price is multiplied by 0.9. In this case, the original assessment price, which corresponds to the price in which there is no reduction due to odors, is reduced by 10%.

The cleaning menu is a combination of one or more cleaning materials (cleaning methods) inside the vehicle that is required to remove (or reduce) odors inside the vehicle. This cleaning method includes, for example, wiping inside the car, ozone deodorization and the like. The cleaning cost is a cost (expense) incurred by executing the cleaning menu. The depreciation factor after cleaning is an expected value of the depreciation factor after the cleaning menu is executed.

The server 10 first refers to the vehicle base price DB 601 in FIG. 6 and calculates the base price of the assessment in accordance with the type and the model year of the vehicle 40 acquired by the acquisition unit 11. The server 10 further refers to the current depreciation price DB 701 in FIG. 7 and extracts the depreciation price of the assessment in accordance with the type of the vehicle 40 and the state of the vehicle 40 acquired by the acquisition unit 11. The server 10 further refers to the odor reduced price DB 801 in FIG. 8 and extracts the depreciation factor, the cleaning menu, the cleaning cost, and the depreciation factor after cleaning in accordance with the type of the vehicle 40 acquired by the acquisition unit 11 and the strength of the odors for each type of the odors.

Then, the server 10 may be calculate, for example, a value obtained by multiplying a value obtained by subtracting a depreciation price G of the assessment from a base price K of the assessment by a depreciation factor Gs as an assessment price S, as shown in the following Expression 1.

S=(K−G)×Gs (1)

Further, the server 10 may calculate, for example, a value obtained by multiplying a value obtained by subtracting the depreciation price G of the assessment from the base price K of the assessment by a depreciation factor Gs₂ after cleaning as an expected assessment price S₂ after the vehicle 40 is cleaned, as shown in the following Expression 2.

S₂=(K−G)×Gs₂ (2)

Next, the output unit 13 of the server 10 outputs, for example, the assessment price calculated by the control unit 12, the cleaning menu, the cleaning cost, and the expected assessment price after the vehicle 40 is cleaned (Step S3). The server 10 may report the assessment price and the like to the assessment terminal 30 or the odor detection apparatus 20 and cause the screen to display them. Accordingly, the person in charge of the assessment operation is able to grasp, for example, the assessment price in accordance with the strength of the odors in the interior of the vehicle 40 for each type of the odors.

### (Example of Reporting Odor of Specific Type)

When the strength of the odor of a specific type is equal to or larger than a threshold based on the information acquired by the acquisition unit 11, the control unit 12 of the server 10 may cause the information indicating the specific type of the odor to be reported to the assessment terminal 30 or the odor detection apparatus 20 from the output unit 13. Accordingly, even in a case in which, for example, the person in charge of the assessment operation is a smoker and is therefore unlikely to notice the odor of cigarettes, it is possible to appropriately notify this person in charge of the presence or the absence of the odor of cigarettes.

(Example of Using the Strength of Odors while In-Vehicle Air Conditioner is Being Operated)

The server 10 may calculate the assessment price and the like using the strength of each type of odor in the interior of the vehicle while an air conditioning apparatus (in-vehicle air conditioner) of the vehicle 40 is being operated. Accordingly, even in a case in which, for example, an odor of cigarettes or an odor of pet animals seeps into the circulation path of the air of the in-vehicle air conditioner, it is possible to appropriately conduct assessments and the like.

In this case, the acquisition unit 11 of the server 10 may acquire, from the vehicle 40, information indicating that the air conditioning apparatus of the vehicle 40 is being operated. In this case, the vehicle 40 may report information indicating the operating state of the air conditioning apparatus from an Electronic Control Unit (ECU) that controls the air conditioning apparatus to the odor detection apparatus 20 or the like via Over The Air (OTA). The odor detection apparatus 20 may then transmit the information indicating the operating state of the air conditioning apparatus and the information on the odors to the server 10. Then, the server 10 may calculate the price regarding the value of the vehicle based on the strength of the odors in the interior of the vehicle 40 for each type of the odors while the air conditioning apparatus of the vehicle 40 is being operated.

### (Example of Measuring Odors by Operating In-Vehicle Air Conditioner)

The server 10 may perform control to operate the air conditioning apparatus (in-vehicle air conditioner) of the vehicle 40 and calculate the assessment price and the like using the strength of the odors in the interior of the vehicle for each type while the in-vehicle air conditioner is being operated. Accordingly, even in a case in which, for example, an odor of cigarettes or an odor of pet animals seeps into the circulation path of the air of the in-vehicle air conditioner, it is possible to appropriately conduct assessments and the like.

In this case, the server 10 may transmit a command for causing, for example, the air conditioning apparatus of the vehicle 40 to operate in an outside air introduction mode to the ECU that controls the air conditioning apparatus of the vehicle 40 via OTA or the like that uses the odor detection apparatus 20. Further, the server 10 may transmit, for example, a command for causing the windows of the vehicle 40 to be closed to the ECU that controls the windows of the vehicle 40 via OTA or the like that uses the odor detection apparatus 20. Then, the server 10 may calculate the price regarding the value of the vehicle based on the strength of the odors in the interior of the vehicle 40 for each type of the odors while the air conditioning apparatus of the vehicle 40 is being operated.

### MODIFIED EXAMPLES

While the server 10 may be an apparatus included in one housing, the server 10 according to the present disclosure is not limited to this. Each of the components of the server 10 may be implemented, for example, by cloud computing composed of one or more computers. Further, at least a part of the processing performed by the server 10 may be executed by at least one of the odor detection apparatus 20, the assessment terminal 30, and the vehicle 40. Further, the server 10 may be an apparatus that is integrated with at least one of the odor detection apparatus 20, the assessment terminal 30, and the vehicle 40. These servers 10 are also included in one example of the “information processing apparatus” according to the present disclosure.

Note that the present disclosure is not limited to the above-described embodiment and may be changed as appropriate without departing from the spirit of the present disclosure.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R (compact disc recordable), CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information processing apparatus comprising:
an acquisition unit configured to acquire information indicating the strength of each type of odor in the interior of a vehicle; and
a control unit configured to calculate the price regarding the value of the vehicle based on the information acquired by the acquisition unit.

2. The information processing apparatus according to claim 1, wherein the control unit respectively calculates, based on an output from a first sensor that detects an odor of a first type with a first sensitivity and detects an odor of a second type with a second sensitivity and an output from a second sensor that detects the odor of the first type with a third sensitivity and detects the odor of the second type with a fourth sensitivity, the strength of the odor of the first type and the strength of the odor of the second type.

3. The information processing apparatus according to claim 1, wherein the control unit causes information indicating the specific type to be reported when the strength of an odor of a specific type is equal to or larger than a threshold based on the information acquired by the acquisition unit.

4. The information processing apparatus according to claim 1, wherein the control unit determines the cleaning materials for the vehicle based on the information acquired by the acquisition unit.

5. The information processing apparatus according to claim 1, wherein the control unit estimates the price regarding the value of the vehicle after the vehicle is cleaned based on the information acquired by the acquisition unit.

6. The information processing apparatus according to claim 1, wherein the control unit calculates the price regarding the value of the vehicle based on the information acquired by the acquisition unit and the type of the vehicle.

7. The information processing apparatus according to claim 1, wherein
the acquisition unit acquires, from the vehicle, information indicating that an air conditioning apparatus of the vehicle is being operated, and
the control unit calculates the price regarding the value of the vehicle based on the strength of each type of odor in the interior of the vehicle while the air conditioning apparatus of the vehicle is being operated.

8. The information processing apparatus according to claim 1, wherein
the control unit transmits a command for causing the air conditioning apparatus of the vehicle to be operated in an outside air introduction mode and a command for causing a window of the vehicle to be closed to the vehicle, and
the control unit calculates the price regarding the value of the vehicle based on the strength of each type of odor in the interior of the vehicle while the air conditioning apparatus of the vehicle is being operated in an outside air introduction mode.

9. An information processing method comprising:
acquiring information indicating the strength of each type of odor in the interior of a vehicle; and
calculating the price regarding the value of the vehicle based on the acquired information.

10. A non-transitory computer readable medium storing a program for causing a computer to execute processing of:
acquiring information indicating the strength of each type of odor in the interior of a vehicle; and
calculating the price regarding the value of the vehicle based on the acquired information.
